(19) United States
(12) Patent Application Publication
(10) Pub. No.: US 2010/0268630 A1
(43) Pub. Date: Oct. 21, 2010

(54) CENTRALIZED RECEIPT DATABASE

(75) Inventor: Eric Holmen, Aliso Viejo, CA (US)

Correspondence Address: DLA PIPER US LLP, 1999 AVENUE OF THE STARS, SUITE 400, LOS ANGELES, CA, 90067-6023, US

(73) Assignee: SMARTREPLY, INC., Irvine, CA (US)

(21) Appl. No.: 12/706,343

(22) Filed: Feb. 16, 2010

Related U.S. Application Data
(60) Provisional application No. 61/152,666, filed on Feb. 13, 2009.

(51) Int. Cl. G06Q 40/00; G06K 5/00; G06F 15/16

(52) U.S. Cl. 705/35; 235/380; 709/206; 455/413

(57) ABSTRACT

The present system provides a method to automatically collect and consolidate transaction information into a single database that can be accessed by a user. The system provides a unique identifier or authorization from a user and whenever that user executes a transaction of any type, whether on-line, in person, with a credit or debit card, or via cash, the particulars of the transaction are recorded and provided to a central database associated with the user so that an automatic history of that user's transactions is recorded.

This patent application claims priority to U.S. Provisional Patent Application Ser. No. 61/152,666 filed Feb. 13, 2009, which is incorporated by reference herein in its entirety.

### BACKGROUND OF THE SYSTEM

An important activity in financial management is the ability to track expenses and expenditures. The ability to follow a budget or to manage accounts requires timely knowledge of payments and other outlays of funds. This is particularly true for individuals that many not have the benefits of an accounting department to help track such matters.

There have been attempts in the prior art to provide more complete and reliable expenditure data to individuals. For example, credit and debit card companies provide an itemized account of card use during a specific billing period (e.g. on a monthly basis). A disadvantage of such a system is the time lag between occurrence and accounting. Often it may be six weeks or more from a transaction before the itemized account is provided. Some credit and debit cards seek to obviate this disadvantage by providing on-line access to usage information. This can provide more timely access to account information, but has the disadvantage of being card and/or account specific. Often an individual desires to track financial transaction from multiple accounts. This requires multiple visits to multiple websites to attempt to coordinate all transaction information.

There have been prior art attempts to consolidate transaction information in a single location for use by an individual. For example, software solutions by providers such as Quicken permit the use to have a single ledger that includes transactions from multiple sources. However, this system is not automatic, but requires the individual collection of transaction information, often via hand entering, limiting its likely use, accuracy, completeness, and timeliness.

One limitation of current systems is that they are limited for the most part to credit or debit transactions that include an electronic component, such as via the use of a card or account number. This ignores the large number of transactions that are cash based.

Another problem with current systems is the use of paper receipts to evidence transactions. On-line transactions utilize digital or electronic receipts that can be stored electronically by the purchaser or printed as desired. By contrast, the majority of in person transactions are evidenced via paper transactions, whether the transaction is credit or cash based.

### BRIEF SUMMARY OF THE SYSTEM

The present system provides a method to automatically collect and consolidate transaction information into a single database that can be accessed by a user. The system provides a unique identifier or authorization from a user and whenever that user executes a transaction of any type, whether on-line, in person, with a credit or debit card, or via cash, the particulars of the transaction are recorded and provided to a central database associated with the user so that an automatic history of that user's transactions is recorded.

### BRIEF DESCRIPTION OF THE DRAWINGS

FIG. 1 is a flow diagram illustrating the initialization of a receipt database account in one embodiment of the system.

FIG. 2 is a flow diagram illustrating the operation of the system in one embodiment.

### DETAILED DESCRIPTION OF THE SYSTEM

The system works by incorporating a reporting capability into current transaction systems such as credit card authorization machines, cash registers, ATM's, vending machines, or any other device used for confirming or executing a transaction. At the option of the user, each transaction can be reported digitally to a central database (the user may still request a paper receipt if desired or if required by local regulations). The user can then review the data in the database by accessing it via a network such as the internet. In one embodiment, a digital copy of the receipt may be immediately transmitted to the user's mobile phone or other mobile device via SMS or other messaging protocol, and/or to an email account to provide a quick acknowledgement of the completion of the transaction. This feature can be useful to help guard against identity theft when the user receives a transaction alert even though the user is not currently executing a transaction.

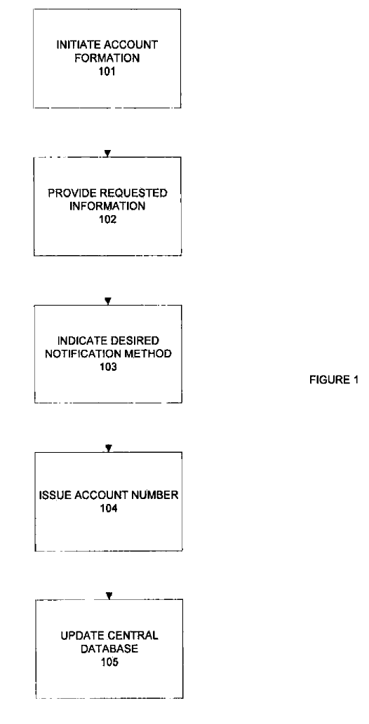

FIG. 1 is a flow diagram illustrating the initialization of a receipt database account in one embodiment of the system. At step 101 the user initiates the account formation program. This can be accomplished via the internet by linking to the web site of the database manager. At step 102 the user provides requested information including name, address, and other information. In one embodiment, the user also includes information about the user's credit and debit cards so that their use will automatically trigger data collection when the card is used. In another embodiment, the user does not provide this information.

At step 103 the user indicates his desired notification method. This may be via text message to a cell phone number or to a mobile messaging address, an email to an email account, and/or some other notification method. At step 104 the user is provided with a unique account number so that the user can participate in the system. This account number can be offered at each transaction where the user desires automatic transaction data collection. This feature of the system allows the system to work even if the user does not provide credit and debit card account information in step 102. It doesn't matter to the system if it knows in advance what credit card belongs to the user. If the user triggers the system by using the account number during a transaction, the transaction data will be automatically provided to the database and associated with the user.

At step 105 the central database is updated so that the user can participate in the system.

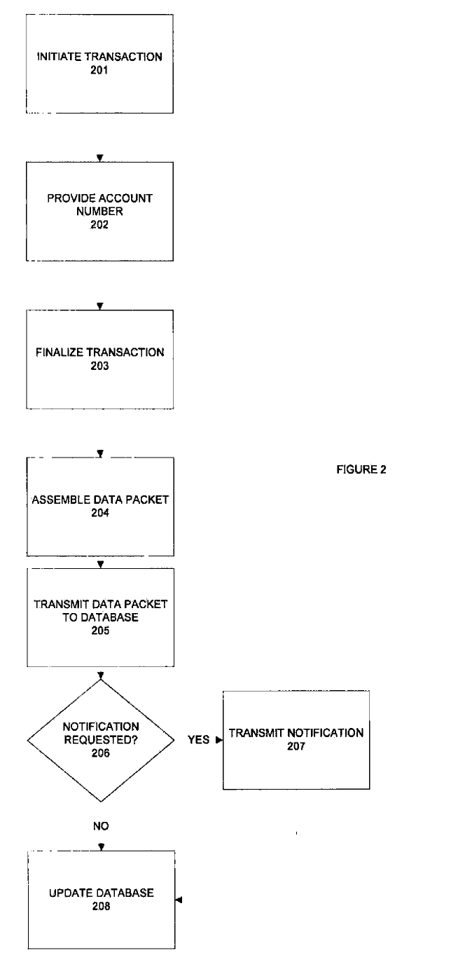

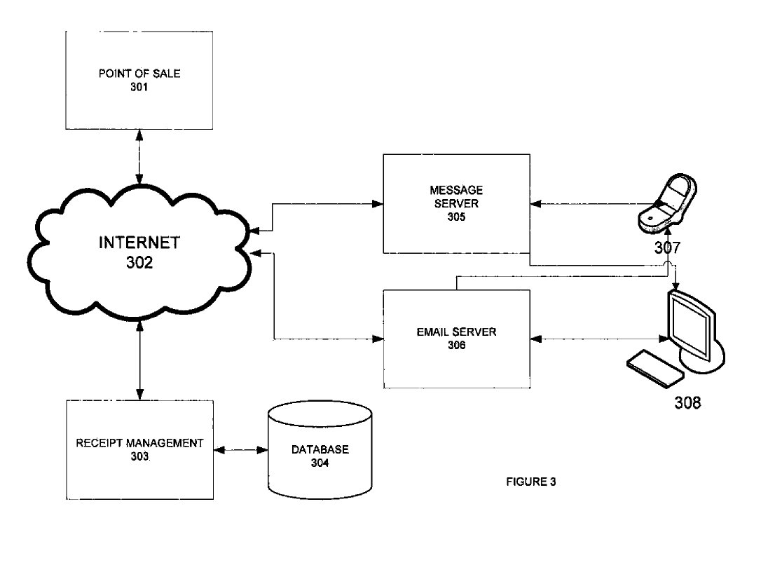

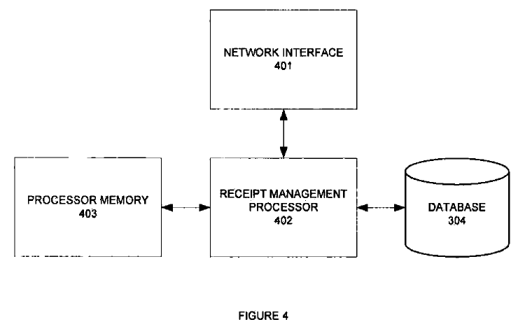

FIG. 2 is a flow diagram illustrating the operation of the system in one embodiment. At step 201 a transaction is initiated. It should be noted that this transaction may be via cash, check, credit card, debit card, or any other appropriate payment means. At step 202 the user provides the merchant with the user's central database account number. This may be done manually, or it may be done via an input pad, or via a swipe machine, an RFID reader, or any other suitable method of transmitting or providing the account information.

At step 203 the transaction is finalized and at step 204 a data packet is assembled. The data packet can have any suitable format. In one embodiment, the data packet includes date, time, amount, method of payment, and nature of goods or services purchased. If desired, the user can specify sub-categories so that the data in the central database has more meaning to the user. By categorizing certain transactions, the user may make it easier for tax or other accounting operations to be performed at a later date.

At step 205 the data packet is transmitted to the central database. At step 206 it is determined if the user has indicated a notification preference. If so, the notification is transmitted at step 207 (e.g. cell phone text message, email, etc.). If not, the database is updated at step 208 and the process is complete for that transaction.

In one embodiment of the system, when the user has provided credit card account information to the central database, the transaction can proceed even without the user's database account number. When the central clearinghouse and credit card processing system receives a transaction for that user, it automatically forwards a transaction history packet to the user's account at the centralized database, and the central database can perform user notification as appropriate and requested.

FIG. 3 is a block diagram of one embodiment of the system. A POS 301 (point of sale location) is coupled through a network such as the internet 302 to the receipt management system 303. The receipt management system 303 includes a database 304 that stores the receipts, personal preferences, and contact information for each participant in the system.

When a user undertakes a transaction at the POS 301, the user provides the user's identification number to the vendor. The number and receipt information is transmitted via internet 302 to the receipt management system 303. The management system 303 confirms the user's identification number and adds the receipt information to the user's account. The receipt management system may then transmit a notice to the user via the internet and either message server 305 to cell phone 307, or via email server 306 to an email account which can be read on the phone 307 and/or a PC 308.

FIG. 4 is a block diagram of the receipt management system 303 of FIG. 3. The receipt management system 303 includes a network interface 401 coupled to a receipt management processor 402. The receipt management processor 402 is coupled to processor memory 403 and database 304. The receipt management processor may be any server or processing based systems. Processor memory 403 may be any suitable memory such as DRAM, SRAM, etc. and may include a region for the storage of an operating system and/or program instructions for the processor 402. The system can implement the steps of flow diagrams described in FIGS. 1 and 2.

In one embodiment of the system, the central database account information can be associated with a merchant loyalty card so that use of the loyalty card initiates the data capture aspects of the system. In one embodiment, the central database account number is the mobile phone number of the user. This makes it easier for the user to remember and use the account number.

In one embodiment, the central database also tracks purchase dates for purposes of warranties and returns. In another embodiment, the user's data can be mined for targeted messaging to the user, particularly when the data is associated with a loyalty card. The targeted messaging could be advertising, discounts, or other relevant information based on the pattern of use by the user.

What is claimed is:

1. A method for automatically collecting transaction information for a user;
associating an account number with a user;
transmitting transaction information associated with the account number to a centralized database for each transaction.

2. The method of claim 1 further including determining a preferred method of notification for the user.

3. The method of claim 2 further including notifying the user when a transaction using the account number has occurred.

4. The method of claim 3 wherein the method of notifying the user comprises a text message.

5. The method of claim 4 wherein the method of notifying the user comprises an email message.

6. The method of claim 5 wherein the method of notifying the user comprises a voice message.

7. The method of claim 1 wherein the account number is associated with a customer loyalty program.

8. The method of claim 1 wherein the transaction is one of a cash, credit, check, or debit transaction.
